(19) United States
(12) Patent Application Publication
(10) Pub. No.: US 2022/0125266 A1
(43) Pub. Date: Apr. 28, 2022

(54) MOBILE HOUSEHOLD APPLIANCE WITH A DISPLAY

(71) Applicant: Vorwerk & Co. Interholding GmbH, Wuppertal (DE)

(72) Inventors: Gerhard ISENBERG, Koeln (DE); Jan DELFS, Bonn (DE); Ingo EHRING, Bottrop (DE); Viktor BEZSONOV, Duesseldorf (DE)

(73) Assignee: Vorwerk & Co. Interholding GmbH, Wuppertal (DE)

(21) Appl. No.: 17/509,107

(22) Filed: Oct. 25, 2021

(30) Foreign Application Priority Data
Oct. 26, 2020 (DE) 10 2020 128 096.3

(51) Int. Cl. A47L 9/28; G06F 1/16

(52) U.S. Cl. CPC A47L 9/2857; A47L 9/2884; G06F 2200/1614; A47L 9/2873; G06F 1/165

(57) ABSTRACT

A mobile household appliance has an appliance housing, a display that forms part of an outer shell of the appliance housing, a detection device for detecting an operating parameter that characterizes an operating mode of the household appliance, and an evaluation and control unit for determining the operating mode and for depicting at least one piece of information concerning the current operating mode on the display. The evaluation and control unit varies a depicting direction of the displayed information depending on the determined current operating mode of the household appliance. The detection device has a sensor that is designed for detecting a relative orientation of a handle of the household appliance, which can be adjusted relative to the appliance housing, or a contact sensor for detecting mechanical contact of the household appliance with a service station, or an accumulator monitoring device for detecting charging or discharging of the accumulator.

### CROSS REFERENCE TO RELATED APPLICATIONS

Applicant claims priority under 35 U.S.C. § 119 of German Application No. 10 2020 128 096.3 filed Oct. 26, 2020, the disclosure of which is incorporated by reference.

### BACKGROUND OF THE INVENTION

### 1. Field of the Invention

The invention pertains to a mobile household appliance, particularly a floor treatment appliance, with an appliance housing, a display that forms part of an outer shell of the appliance housing, a detection device for detecting an operating parameter that characterizes an operating mode currently carried out by the household appliance and an evaluation and control unit for determining the operating mode based on the operating parameter and for depicting at least one piece of information concerning the current operating mode on the display.

In addition, the invention pertains to a method for operating a mobile household appliance, particularly a method for operating a floor treatment appliance, wherein an operating parameter that characterizes an operating mode currently carried out by the household appliance is detected, wherein the current operating mode is determined based on the detected operating parameter, and wherein information concerning the determined current operating mode is depicted on a display of the household appliance.

### 2. Description of the Related Art

Mobile household appliances with a display for depicting information are sufficiently known from the prior art. The mobile household appliances may be appliances, which with respect to their location can be displaced autonomously or manually by a user.

It is known to depict information concerning the operation of the household appliance, characteristics of the environment or also options for the operation of the household appliance on a display of the household appliance. This usually takes place with a fixed depicting direction of the information relative to the display. The depicting direction usually is chosen such that a user can optimally read the information, particularly text information, when the user is located in front of the household appliance—referred to a main moving direction of the mobile household appliance. Furthermore, different types of detection devices for autonomously moving floor treatment appliances such as ultrasonic sensors, contact sensors, camera systems and the like are known from the prior art.

Since the position of the user relative to the household appliance can change in the course of its operation, situations may arise, in which the user has to read information shown on the display “upside down.”

### SUMMARY OF THE INVENTION

Based on the above-described prior art, the invention aims to develop a mobile household appliance, in which the depiction of information on the display is additionally improved.

In order to attain this objective, the invention proposes a mobile household appliance, the evaluation and control unit of which is designed for varying a depicting direction of the information depicted on the display in dependence on the determined current operating mode of the household appliance, wherein the detection device has a sensor that is selected from the following group: a sensor that is designed for detecting a relative orientation of a handle of the household appliance, which can be adjusted relative to the appliance housing; a contact sensor for detecting mechanical contact of the household appliance with a service station; an accumulator monitoring device that is designed for detecting charging or discharging of the accumulator.

According to the invention, the operating mode currently carried out by the household appliance therefore is determined in order to advantageously depict one or more pieces of information for a user on the display. The evaluation and control unit particularly is designed for indirectly surmising an operating direction or at least a viewing direction of the user at the display in dependence on current parameters of the household appliance. In this case, the orientation of the information depicted on the display is adapted in dependence on a current operating mode of the household appliance in order to allow better readability of the information for the user depending on an operationally dependent usual orientation of the household appliance. The direction, from which the user usually looks at the display of the household appliance in a certain operating mode, is taken into account in this case. Consequently, a depiction of the information on the display changes, for example, when the mobile household appliance switches from a charging position at a base station to a different usage position while a household activity is carried out by the household appliance.

In order to detect an operating parameter of the household appliance, the detection device has a sensor that is selected from the following group: a sensor that is designed for detecting a relative orientation of a handle of the household appliance, which can be adjusted relative to the appliance housing; a contact sensor for detecting mechanical contact of the household appliance with a service station; an accumulator monitoring device that is designed for detecting charging or discharging of the accumulator. In addition to the aforementioned sensors, it would also be conceivable to use other types of sensors that measure a parameter providing information on an operating mode currently carried out by the household appliance. According to an exemplary embodiment, a usage position of the household appliance during the operating mode being carried out is detected. This can be realized by means of a position sensor that detects the orientation of the household appliance. Furthermore, the household appliance may have a handle that, for example, can be displaced relative to the appliance housing and assumes a certain orientation relative to the appliance housing of the household appliance in dependence on a chosen operating mode. Consequently, the information on the respective position or orientation of the handle can be used for depicting information on the display of the household appliance. When the household appliance is in an idle position, particularly a parking position in a storage closet or the like, or docked with a charging station or service station, for example, a contact sensor of the household appliance or of an attachment connected to the household appliance can detect the docking with a corresponding counterpart of a floor surface, the charging station or the service station. Furthermore, the detection device may be designed for detecting the states of an accumulator circuit. For example, a correspondingly proposed accumulator monitoring device may detect if energy currently is drawn from or fed to the accumulator. Depending on this, it can be deduced, for example, that the household appliance currently is operated in a working mode and therefore draws energy from the accumulator. However, if the accumulator monitoring device detects that energy currently is fed to the accumulator, it can be deduced that the accumulator is connected to a charging station or a mobile charger. A parameter measured by means of the position sensor can be additionally evaluated in order to distinguish, for example, whether the household appliance stands at a charging station or is connected to a charger in a reclined manner. A current operating mode of the household appliance can then be determined by combining the information of the accumulator monitoring device and the information of the position sensor. Depending on these pieces of information, the evaluation and control device then can in turn adapt the depicting direction on the display. Furthermore, the detection device of the household appliance also may be designed, for example, for detecting a defined auxiliary current that can only be delivered by the stationary charging station. If the household appliance is not connected to a charging station, but rather to a mobile charger, the lack of the auxiliary current enables the detection device of the household appliance to determine that the household appliance is not connected to a charging station.

It is proposed that the evaluation and control unit is designed for deducing in dependence on the operating mode a spatial orientation of the household appliance and/or a viewing direction of a user at the household appliance during the operating mode. This embodiment is based on the realization that certain operating modes of the household appliance usually involve a certain spatial orientation of the household appliance relative to the environment or relative to the position and orientation of the user, respectively. In the case of an exemplary household appliance in the form of a hand-operated vacuum cleaner, which the user usually pushes in front of himself during a working mode, the user looks at the display in a so-called “six o'clock viewing direction” during the working mode. However, if the same vacuum cleaner currently is connected to a base station in order to charge its accumulator, the vacuum cleaner usually stands upright in front of a wall and the user looks at the display relatively head-on, e.g. in a so-called “12 o'clock viewing direction” that extends opposite to the viewing direction during the working mode. In order to enable the evaluation and control unit of the household appliance to deduce the orientation of the household appliance or the viewing direction of the user—and therefore the required depicting direction of the information on the display—in dependence on the operating mode, the evaluation and control unit accesses a data memory, which contains defined allocations between the respective operating mode and the spatial orientation of the household appliance or the viewing direction of the user.

It is particularly proposed that the household appliance has a data memory, which is communicatively linked to the evaluation and control unit and in which on the one hand a plurality of potential operating modes of the household appliance and on the other hand depicting directions of information on the display allocated to the operating modes are stored. For example, the data stored within the data memory may be available in table form, linked to one another or be available in any other form familiar to a person skilled in the art. It is essential that the evaluation and control unit can obtain information on the depicting direction to be adjusted in dependence on the information on the current operating mode of the household appliance in order to subsequently control the depicting direction of information on the display in dependence on the obtained information.

It is furthermore proposed that the operating mode is selected from the following group: a working mode, in which the user utilizes the household appliance as intended for carrying out a household task, particularly a floor treatment task; a charging mode, in which the household appliance is connected to a charger or a charging station in order to charge an accumulator; a service mode, in which the household appliance is docked with a service station in order to receive a service; an idle mode, in which the household appliance is parked outside of a working mode, charging mode and service mode. The potential operating modes of the household appliance therefore are at least a working mode, a charging mode, a service mode and an idle mode. All these operating modes usually involve different orientations of the household appliance relative to its environment or relative to a user looking at the household appliance or its display, respectively. It would also be possible that the household appliance not only can be operated in a single operating mode, but rather in a plurality of different operating modes. In the above-described example, in which the household appliance is a vacuum cleaner, a first operating mode may involve, for example, cleaning of a floor surface, a second operating mode may involve cleaning of a surface above the floor, e.g. a shelf bottom, a baseboard or the like, and a third operating mode may involve cleaning of wall-ceiling areas, which usually requires an overhead utilization of the household appliance. In all these operating modes, the user assumes a different position relative to the household appliance such that the display of the household appliance may be arranged underneath, adjacent to or above the user and the user therefore respectively looks at the display from above, from the side or from below. In an exemplary comparison between a floor treatment and a ceiling treatment, the viewing directions of the user at the display are rotated relative to one another by approximately 180 degrees such that the evaluation and control unit preferably is designed for rotating the depicting direction for information depicted on the display by +/−180 degrees relative to a previous depicting direction.

It would furthermore be possible that the information depicted on the display of the household appliance is in dependence on the determined current operating mode of the household appliance selected from the following group: information on the charge state of the accumulator; information on the operating mode of the household appliance; information on an accessory connected to the household appliance. According to this embodiment, not only the depicting direction of the information on the display of the household appliance is adapted in dependence on the current operating mode of the household appliance, but rather also the respective type or content of the depicted information. In this way, the evaluation and control unit of the household appliance is designed for filtering and adapting the content of the information depicted on the display to the respective current operating mode. It is advantageous that the user therefore only receives currently relevant pieces of information such that the user is not overstrained with a plurality of pieces of information or display panels, which in part have no relevance for the current operating mode. For example, the information depicted on the display may be information on the charge state of the accumulator if the accumulator currently is in a working mode or in a charging mode. During a working mode of the household appliance, for example, information on an accessory connected to the household appliance can be additionally depicted on the display. All in all, the relevant pieces of information for the respective application of the household appliance to be depicted are purposefully selected from a plurality of basically available and depictable pieces of information. The depiction of one or more pieces of information on the display can be read particularly well by the user. The user is not overstrained with many unnecessary and irrelevant pieces of information on the display, but rather merely receives defined, pre-filtered pieces of information from a quantity of parameters that in principle are detected by the detection device of the household appliance. All in all, the evaluation and control unit according to the preceding description therefore is designed for only selecting at least one piece of information, which is defined as relevant for the current operating mode of the household appliance, from a plurality of available pieces of information and for depicting the at least one selected piece of information on the display.

Furthermore, the display may be a separable or inseparable component of the appliance housing or a separable or inseparable component of an accumulator of the household appliance. It would furthermore be possible that the accumulator is a separable or inseparable component of the household appliance. The display and/or the accumulator therefore may be designed in an exchangeable manner. Furthermore, a surface of the accumulator or the display may also form part of the outer shell of the appliance housing. According to an embodiment, the accumulator can be removed from the household appliance or the appliance housing. The display may either be installed in the appliance housing or in the accumulator, namely either separably or inseparably relative thereto. Alternatively, the accumulator also may not be a component of the outer shell of the appliance housing, but rather be recessed into the appliance housing relative to its outer contour, wherein the display can in this case be read from outside the household appliance through a window of sorts. Furthermore, the accumulator may be permanently connected to the household appliance, i.e. such that it cannot be separated from the appliance housing without being destroyed. In addition to the proposed display, the household appliance may also have other indicator elements. These indicator elements may be realized, for example, in the form of individual LEDs.

In addition to the above-described mobile household appliance, the invention furthermore proposes a method for operating a mobile household appliance, particularly a method for operating a floor treatment appliance, wherein an operating parameter that characterizes an operating mode currently carried out by the household appliance is detected, wherein the current operating mode is determined based on the detected operating parameter and information concerning the determined current operating mode is depicted on a display of the household appliance, wherein a depicting direction of the information depicted on the display is varied in dependence on the determined current operating mode of the household appliance, and wherein the detection device has a sensor that is selected from the following group: a sensor that is designed for detecting a relative orientation of a handle of the household appliance, which can be adjusted relative to the appliance housing; a contact sensor for detecting mechanical contact of the household appliance with a service station; an accumulator monitoring device that is designed for detecting charging or discharging of the accumulator. In the course of carrying out the method, an evaluation and control unit of the household appliance particularly can deduce in dependence on the operating mode a spatial orientation of the household appliance and/or a viewing direction of a user at the household appliance during the operating mode. The relevant characteristics and advantages of the method are realized as described above with reference to the mobile household appliance. In order to avoid unnecessary repetitions, we refer to the preceding description in this respect.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a mobile household appliance during a first operating mode; and

FIG. 2 shows the household appliance during a second operating mode.

### DETAILED DESCRIPTION OF PREFERRED EMBODIMENTS

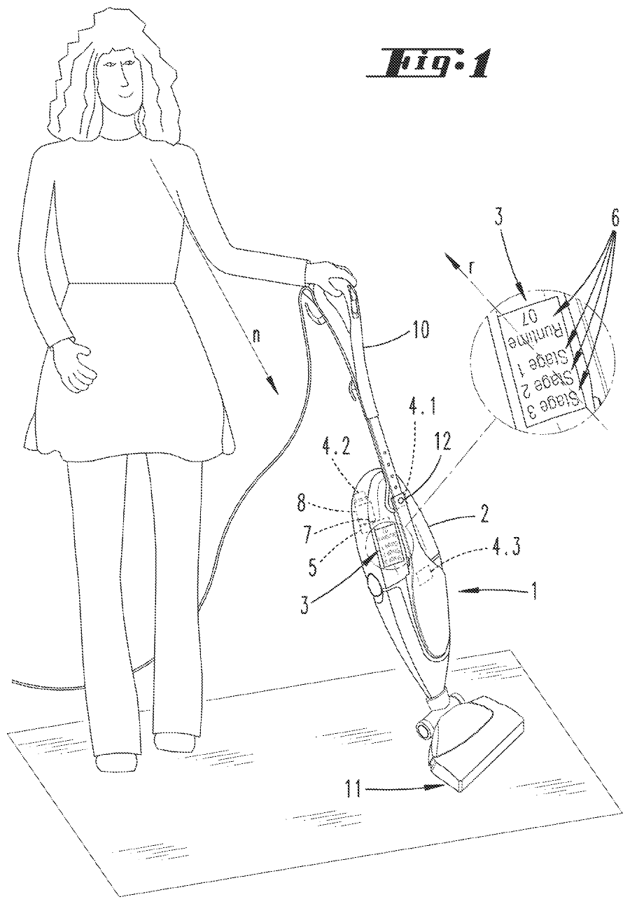

FIG. 1 shows a mobile household appliance 1, which in this example is realized in the form of a household appliance 1 that can be pushed over a floor surface to be treated by a user. For example, the household appliance 1 is a vacuum cleaner, a mop or a combined vacuuming-mopping appliance. The household appliance 1 has an appliance housing 2 and a handle 10 that is pivotably mounted on the appliance housing. A display 3 is flushly integrated into the surface of the appliance housing 2 and separably or inseparably connected to the appliance housing 2. The household appliance 1 furthermore has an accumulator 8 that serves for supplying energy to electrical consumers of the household appliance 1. These electrical consumers may consist, for example, of electric motors that serve for operating a drive system of the household appliance, a cleaning device or the like. As an alternative to an integration into the appliance housing 2, the display 3 may also integrated into a surface of the accumulator 8, in which case the appliance housing 2 has a recess or a viewing window, through which the display 3 can be read from outside. An evaluation and control unit 5 of the household appliance 1 controls a depiction of pieces of information 6, which are useful for the user during the utilization of the household appliance 1, on the display 3. The depiction of the pieces of information 6 takes place with a depicting direction r, which based on the viewing angle of the user corresponds to a reading direction from “top left” to “bottom right.” A data memory 7 containing a plurality of data on different operating modes of the household appliance 1, particularly the pieces of information 6 for the user concerning the operating modes, is allocated to the evaluation and control unit 5. Furthermore, the data memory 7 contains—as described in greater detail further below—information on normal viewing directions n of the user at the household appliance 1 during the respective operating mode and therefore also on a spatial orientation of the household appliance 1 during this operating mode, wherein said normal viewing directions and spatial orientations are respectively allocated to the different operating modes.

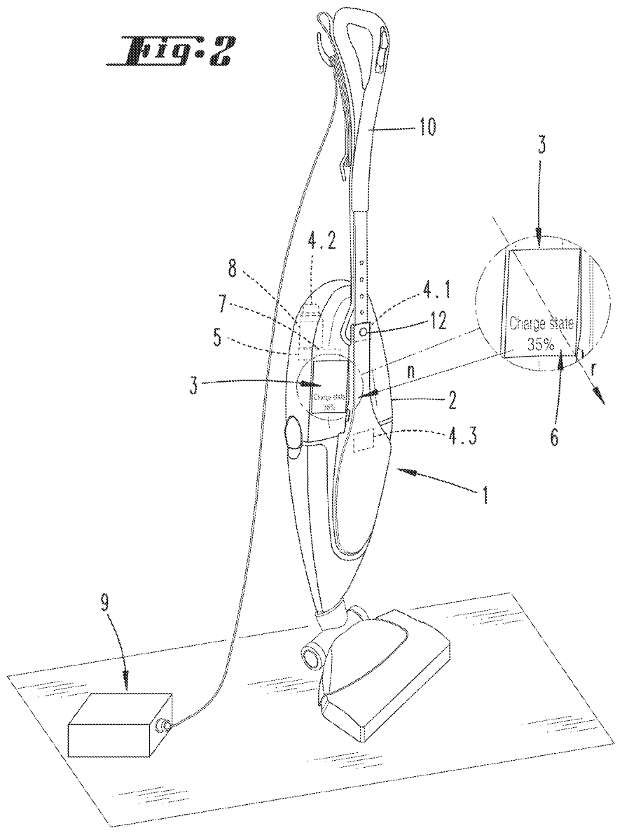

In this case, the household appliance 1 has several possible operating modes such as, for example, a working mode, in which the household appliance 1 carries out a floor treatment (FIG. 1), a charging mode, in which the accumulator 8 of the household appliance 1 is charged by means of a charger 9 (FIG. 2), and an idle mode, in which the household appliance 1 is turned off and stored, for example, in a closet. It would also be possible to provide other operating modes such as a service mode or multiple service mode modes, in which the household appliance 1 receive a service from a service station, for example a transfer or maintenance of an accessory 11 connected to the appliance housing 2. For example, such an accessory 11 may be a vacuum nozzle, a rotating floor treatment brush, a mopping plate, a polishing attachment or the like.

In order to determine an operating mode currently carried out by the household appliance 1, the household appliance 1 has a sensor system that in this example comprises a total of three individual detection devices 4.1, 4.2 and 4.3. In this case, the detection device 4.1 is allocated to a joint 12 between the appliance housing 2 and the handle 10 and designed for detecting a current position of the variable handle 10 relative to the appliance housing 2. For example, the detection device 4.1 may be a contact sensor or an optical sensor that can detect a positioning of the handle 10 in a defined pivoting position. In this example, the detection device 4.2 forms part of an accumulator monitoring device, which can detect whether energy currently is drawn from the accumulator 8 or fed to the accumulator 8. The accumulator monitoring device may form part of a charge control. For example, the detection device 4.3 is a position sensor that can measure an orientation of the household appliance 1. It is particularly preferred that the position sensor is a gyroscope or an acceleration sensor. Consequently, the detection device 4.3 can determine, for example, if the household appliance 1 stands upright as illustrated in FIG. 1, is held horizontally in order to treat surfaces above the floor or held overhead in order to treat a ceiling area of a room such that the accessory 11 is located above the user.

In order to further elucidate the invention, FIGS. 1 and 2 show a comparison between two different operating modes of the household appliance 1. In FIG. 1, a user pushes the household appliance 1 over a floor surface to be treated during a working mode, wherein the user respectively pushes and pulls the household appliance 1 in front of himself in the form of regular or irregular movements. In this case, the appliance housing 2 of the household appliance 2 usually is positioned essentially upright (referred to a longitudinal extent). The user is located behind the household appliance 1 while holding the handle 10 in order to displace the household appliance 1. In this operating mode, the user looks at the display 3 in a viewing direction n that essentially corresponds to a viewing direction at the display 3 from above. This viewing direction can generally also be referred to as “six o'clock viewing direction.” In this viewing direction n, the evaluation and control unit 5 of the household appliance 1 controls the depiction of pieces of information 6 on the display 3 in such a way that the pieces of information 6 are viewed from outside “upside down” as illustrated in FIG. 1. In this way, the user looking at the display 3 from above can read the pieces of information 6 in the usual manner.

In contrast, FIG. 2 shows the household appliance 1 in an operating mode that differs from FIG. 1 and in this case is a charging mode, in which the accumulator 8 of the household appliance 1 is charged by means of a charger 9. In this example, the charger 9 is a mobile charger. During the charging mode, the household appliance 1 likewise is in an upright position and the user usually looks at the display 3 head-on such that he reads the pieces of information 6 depicted on the display 3 in the usual manner from top left to bottom right. This viewing direction n of the user corresponds to a so-called “12 o'clock viewing direction.” Accordingly, the depicting direction r of the pieces of information 6 on the display 3 essentially is oriented in the opposite direction.

In order to enable the evaluation and control unit 5 of the household appliance 1 to arrange and depict the pieces of information 6 on the display 3 in such a way that a user can read the pieces of information 6 on the display 3 in the usual manner, namely from “top left” to “bottom right” referred to the viewing direction n, in dependence on the operating mode currently carried out by the household appliance 1, the evaluation and control unit 5 is designed for initially determining the current operating mode of the household appliance 1 and for deducing the current spatial orientation of the household appliance 1 or of the display 3 in dependence on the determined operating mode. Furthermore, the evaluation and control unit 5 of the household appliance 1 determines which of multiple available pieces of information 6 are advantageously depicted on the display 3 for the user because not all available pieces of information 6 are actually relevant for the operating mode currently carried out by the household appliance 1.

In the operating mode according to FIG. 1, namely the working mode, the detection device 4.1 detects as a first operating parameter that the handle 10 is oriented on the household appliance 1 in extension of the longitudinal extent of the appliance housing 2. Based on this position of the handle 10, the evaluation and control unit 5 deduces that the user probably is located behind the household appliance 1, namely on the side of the handle 10. The evaluation and control unit 5 carries out an evaluation by accessing the data memory 7 of the household appliance 1, in which detection signals of the detection devices 4.1, 4.2 and 4.3 corresponding to the respective operating mode of the household appliance 1 are stored. In the embodiment according to FIG. 1, the additional detection device 4.2 detects as a further operating parameter that energy currently is drawn from the accumulator 8. In addition, the detection device 4.3, namely the position sensor, detects that the household appliance 1 stands upright, namely such that the accessory 11 is located underneath the appliance housing 2 and the handle 10. The evaluation and control unit 5 now compares the operating parameters detected by the detection devices 4.1, 4.2 and 4.3 with operating parameters that are stored in the data memory 7 and characterize defined operating modes. It is then determined that the household appliance 1 currently carries out the operating mode “working mode” with the aid of the data stored in the data memory 7.

Based on the information of the thusly determined current operating mode of the household appliance 1, the evaluation and control unit 5 subsequently retrieves the viewing direction n of the user that corresponds to the determined operating mode from the quantity of data stored in the data memory 7. In this case, the viewing direction n of the user illustrated in FIG. 1 is allocated to the operating mode “working mode” of the household appliance 1. Furthermore, the data memory 7 also contains the useful pieces of information 6 for the user to be depicted on the display 3 during the respective operating mode. During the working mode, these pieces of information 6 are, for example, a selected or chosen power stage of a fan or cleaning element. The stages “stage 1,” “stage 2” and “stage 3” preferably can be selected by the user by touching the display 3. Furthermore, a runtime, for which the household appliance 1 presumably can still operate with the residual energy remaining in the accumulator 8, is depicted for the user in minutes.

In contrast, different pieces of information 6, particularly information 6 on the current charge state of the accumulator 8, are relevant for the user in the operating mode of the household appliance 1 according to FIG. 2, namely in the charging mode for the accumulator 8. However, other pieces of information 6 that basically can be retrieved, namely the pieces of information 6 on selectable power stages of the household appliance 1 illustrated in FIG. 1, are not selected by the evaluation and control unit 5 for the depiction on the display 3. The evaluation and control unit 5 can detect the charging mode of the household appliance 1 based on the operating parameter that is detected by the detection device 4.2 and indicates that energy is fed to the accumulator 8. However, the remaining operating parameters, namely the position of the handle 10 and the orientation of the household appliance 1, essentially are identical to those in to FIG. 1.

Although only a few embodiments of the present invention have been shown and described, it is to be understood that many changes and modifications may be made thereunto without departing from the spirit and scope of the invention.

### LIST OF REFERENCE SYMBOLS

1 Household appliance
2 Appliance housing

### 3 Display

4.1 Detection device
4.2 Detection device
4.3 Detection device
5 Evaluation and control unit

### 6 Information

7 Data memory

### 8 Accumulator

### 9 Charger

### 10 Handle

### 11 Accessory

### 12 Joint

n Viewing direction
r Depicting direction

What is claimed is:

1. A mobile household appliance comprising:
an appliance housing,
a display that forms part of an outer shell of the appliance housing,
a detection device configured for detecting an operating parameter that characterizes an operating mode currently carried out by the household appliance, and
an evaluation and control unit configured for determining the operating mode based on the operating parameter and for depicting at least one piece of information concerning the current operating mode on the display,
wherein the evaluation and control unit is designed for varying a depicting direction (r) of the information depicted on the display depending on the determined current operating mode of the household appliance, and
wherein the detection device has a sensor that is selected from the group consisting of: a sensor that is designed for detecting a relative orientation of a handle of the household appliance, which can be adjusted relative to the appliance housing; a contact sensor configured for detecting mechanical contact of the household appliance with a service station; and an accumulator monitoring device that is designed for detecting charging or discharging of the accumulator.

2. The household appliance according to claim 1, wherein the evaluation and control unit is designed for deducing in dependence on the operating mode a spatial orientation of the household appliance and/or a viewing direction of a user at the household appliance during the operating mode.

3. The household appliance according to claim 1, further comprising a data memory, which is communicatively linked to the evaluation and control unit and in which a plurality of potential operating modes of the household appliance and depicting directions (r) of information on the display allocated to the operating modes are stored.

4. The household appliance according to claim 1, wherein the operating mode is selected from the group consisting of: a working mode, in which the user utilizes the household appliance as intended for carrying out a household task, particularly a floor treatment task; a charging mode, in which the household appliance is connected to a charger or a charging station in order to charge an accumulator; a service mode, in which the household appliance is docked with a service station in order to receive a service; and an idle mode, in which the household appliance is parked outside of a working mode, charging mode and service mode.

5. The household appliance according to claim 1, wherein the depicted information depends on the determined current operating mode of the household appliance selected from the group consisting of: information on a charge state of the accumulator; information on the operating mode of the household appliance, and information on an accessory connected to the household appliance.

6. The household appliance according to claim 1, wherein the evaluation and control unit is designed for only selecting at least one piece of information, which is defined as relevant for the current operating mode of the household appliance, from a plurality of available pieces of information and for depicting the at least one selected piece of information on the display.

7. The household appliance according to claim 1, wherein the display is a separable or inseparable component of the appliance housing or a separable or inseparable component of an accumulator of the household appliance.

8. The household appliance according to claim 7, wherein the accumulator is a separable or inseparable component of the household appliance.

9. A method for operating a mobile household appliance, comprising the following steps:
detecting an operating parameter that characterizes an operating mode currently carried out by the household appliance,
determining the current operating mode based on the detected operating parameter,
depicting information concerning the determined current operating mode on a display of the household appliance,
wherein a depicting direction (r) of the information depicted on the display is varied depending on the determined current operating mode of the household appliance,
wherein the detection device has a sensor that is selected from the group consisting of: a sensor that is designed for detecting a relative orientation of a handle of the household appliance, which can be adjusted relative to an appliance housing; a contact sensor for detecting mechanical contact of the household appliance with a service station; and an accumulator monitoring device that is designed for detecting charging or discharging of the accumulator.
